(19) United States
(12) Patent Application Publication
(10) Pub. No.: US 2011/0027433 A1
(43) Pub. Date: Feb. 3, 2011

(54) ELIMINATION OF UNWANTED ACCOMPANYING SUBSTANCES FROM VEGETABLE PROTEIN EXTRACTS

(75) Inventors: Friedrich Ruf, Ast (DE); Ulrich Sohling, Freising (DE); Katrin Hasenkopf, Freising (DE); Peter Eisner, Freising (DE); Klaus Müller, Freising (DE); Claudia Pickardt, Freising (DE); Jürgen Bez, Munich (DE)

Correspondence Address: CONNOLLY BOVE LODGE & HUTZ LLP, 1875 EYE STREET, N.W., SUITE 1100, WASHINGTON, DC, 20006, US

(73) Assignee: Sud-Chemie AG, Munich (DE)

(21) Appl. No.: 12/681,558

(22) PCT Filed: Oct. 2, 2008
(86) PCT No.: PCT/EP2008/008384

§ 371 Date: Oct. 22, 2010

(30) Foreign Application Priority Data
Oct. 4, 2007 (DE) 10 2007 047 341.0
Oct. 5, 2007 (DE) 10 2007 047 764.5

(51) Int. Cl. A23J 3/14; A23L 1/28; A23L 1/27; A23L 1/015

(52) U.S. Cl. 426/270; 426/271; 426/656

(57) ABSTRACT

The invention relates to a method for eliminating unwanted accompanying substances, particularly fragrance, flavor, and colour components, from vegetable proteins. Said method encompasses the following steps: (i) a vegetable raw material is extracted using an extracting agent such that, a vegetable protein extract is obtained; (ii) an inorganic adsorber material is added to the vegetable protein extract, a process in which unwanted accompanying substances, especially fragrance, flavor, and/or colour components, are bonded to the inorganic adsorber material.

The invention relates to a method for eliminating unwanted accompanying substances, particularly fragrance, flavour and/or colour components, from vegetable protein extracts, as well as the use of inorganic adsorber materials for eliminating unwanted accompanying substances, particularly fragrance, flavour and/or colour components, from vegetable protein extracts.

### BACKGROUND OF THE INVENTION

The use of vegetable proteins in foods instead of animal raw materials, such as egg or milk, is increasing in importance. Vegetable proteins display very good techno-functional properties in a large number of food applications. Protein preparations from raw materials, such as soya, lupin, sunflower, rapeseed or other protein-containing plant seeds, are used in foods for example as water binders, oil binders, gelling agents, emulsifiers or foaming agents. Vegetable proteins are also very valuable for nutrition physiology reasons and can increase the value of foods in terms of healthiness. In addition, vegetable proteins are suitable for use in pet food. Vegetable proteins serve in these cases to improve structure and texture and provide protein enrichment at a favourable cost.

Vegetable proteins can be obtained for example by aqueous extraction from vegetable raw materials. The vegetable proteins can be precipitated from the aqueous extract for example by changing the pH and separated as vegetable protein concentrate.

However, the thus-obtained vegetable protein concentrates often have a typical, distinctive fragrance profile, which is undesirable for food applications and pet food. Thus, protein extracts from legumes, such as soya, pea or lupin, have a fragrance typical of legumes which is described by test subjects in sensory taste tests as grassy, bean-like, pea-like or green. Rapeseed and sunflower often produce bitter and astringent taste impressions. In addition, the polyphenols often associated with the proteins react with the proteins and thus negatively alter the colour and quality of the vegetable protein concentrates.

The reason for these fragrance defects lies in the presence of secondary vegetable substances, such as polyphenols, phytic acid and alkaloids. In addition, a large number of aldehydes and ketones, which are said to be responsible for many fragrance defects, result from fat breakdown reactions.

Attempts have been made using various methods to separate these unwelcome accompanying substances, particularly fragrance, flavour and/or colour components, from the extracted vegetable proteins or to mask their fragrance.

Usual methods for eliminating unwanted accompanying substances from vegetable protein concentrates are extraction and washing steps. Soluble components are extracted from the vegetable protein concentrate under conditions in which the proteins are as poorly soluble as possible. The extraction can take place with aqueous, with aqueous-alcoholic or with organic solvents. A disadvantage is that most often several extraction stages are needed to separate the unwanted accompanying substances to an adequate extent. The method is thus very laborious and cost-intensive. In addition, large quantities of water/solvent are necessary. In aqueous systems, the solubility of the secondary vegetable substances is often relatively low, with the result that the depletion is very poor. In addition, relatively large quantities of protein are also lost during the separation of unwelcome accompanying substances. In the case of extractions with alcohol and other solvents, high costs are incurred for equipping the installations in explosion protection operation.

To improve the solubility of phenolic compounds in aqueous systems, there can be an upstream enzymatic hydrolysis of the phenolic compounds (WO 96/39859). However, the method becomes still more expensive because of the costs of the enzymes.

Filtration methods are also used to separate out. low molecular weight compounds. For example accompanying substances can be separated from soya by ultrafiltration. However, this separation method is very cost-intensive and protracted. The membranes used for the filtration become clogged easily, which greatly slows down the throughflow or even makes a regeneration of the membranes necessary. The risk of unwanted germ growth is also very great due to the long duration of the filtration process. In addition, many accompanying substances are relatively strongly bonded to the protein and often remain in the retentate. A very long wash would then be needed. However, this lengthens the process further and intensifies the named problems.

In EP 1 512 324 A1, soya is treated at pH 9-12 in order to detach accompanying substances from the protein. However, this high pH has the disadvantageous effect that the protein is already partially hydrolyzed, which strongly affects its technological properties. In addition, under these conditions, saponification of residual fat can occur even in de-oiled material, which greatly impairs the sensory qualities of the obtained protein concentrate.

A further method for eliminating unwanted accompanying substances, particularly fragrance, flavour and/or colour components, which form during the oxidation of fats is to treat the protein extract with hoc steam, so-called steam stripping (EP 0 124 165). The protein extract is introduced in a thin layer. However, this process is very expensive in terms of apparatus and eliminates only steam-volatile fragrance components.

A further approach to the elimination of unwanted accompanying substances from protein extracts is to separate them by means of adsorbtive methods. Activated charcoal, known to be a very effective adsorber, is; often used (DE 2627613). However, it is hardly possible any longer to separate the activated charcoal quantitatively from the extracts. Because of the consequent, blackening the use of such vegetable protein concentrates is limited to a few possible applications.

In addition, the use of organic adsorbtive resins (WO 93/21937) as well as special organic molecules (Singh et al. , J. Agric. Food Chem., 1997, 45, 4522) is described. Although these substances are successful in separating out specific ingredients, they act only very specifically on certain structures, are very expensive and difficult to dispose of.

The described methods effect a depletion of unwanted accompanying substances in vegetable protein extracts and contribute to the improvement of the sensory qualities of the vegetable protein concentrates. However, these methods, in particular aqueous extraction methods, are often not effective enough and the products still do not have the required neutrality of flavour and odour. Although other known methods are more effective than those described in the above state of the art, either the outlay on apparatus with these methods is very great, and thus the method is very expensive, or the disposal of the used chemicals is problematic.

### DESCRIPTION OF THE INVENTION

It was therefore the object of the present invention to provide a method for eliminating unwanted accompanying substances, particularly fragrance, flavour and/or colour components, from vegetable protein extracts, with which sensory-neutral and pleasant protein concentrates can be prepared from vegetable raw materials. The vegetable protein concentrates obtained with the method are to be suitable for use in food and pet food, wherein these protein concentrates are also to be capable of being used in higher concentrations without the need to accept impairments of the sensory qualities.

This object is achieved by a method with the features of claim 1. Advantageous embodiments of the method according to the invention are the subject of the dependent, claims.

According to the invention, inorganic adsorber materials are used to eliminate unwanted accompanying substances, particularly fragrance, flavour and/or colour components, from vegetable protein extracts. It was found that, by using such inorganic adsorber materials, unwelcome accompanying substances can be eliminated from vegetable protein extracts with high selectivity without the need to accept high protein losses.

The present invention thus relates to a method for eliminating unwanted accompanying substances, particularly fragrance, flavour and/or colour components, from vegetable protein extracts, at least comprising the following steps:
i. extracting a vegetable raw material using an extracting agent, wherein a. vegetable protein extract is obtained;
ii. adding an inorganic adsorber material to the vegetable protein extract, wherein unwanted accompanying substances, particularly fragrance, flavour and/or colour components, are bonded to the inorganic: adsorber material.

In the method according to the invention, a vegetable raw material is first extracted using an extracting agent. Any vegetable raw material per se can be used as vegetable raw material. Preferably, vegetable raw materials which contain a high proportion of vegetable proteins are used. Both plants themselves and waste which accumulates during the processing of plants can be used. A suitable vegetable raw material is for example a press cake such as forms when producing oil from plant seeds. The vegetable raw materials preferably used have a dry mass of more than 80 wt. -%, preferably more than 90 wt. -%, particularly preferably in the range of from 90 to 95 wt. -%, relative to the weight of the vegetable raw material. The vegetable raw materials preferably used thus have a low water content. In the case of these vegetable raw materials, the dry mass of the vegetable raw material thus corresponds, as a first approximation, to the weight of the vegetable raw material.

The vegetable raw material is then extracted using an extracting agent. Solvents which can be eliminated residue-free or which do not display a harmful effect when consumed by a person or animal are preferably used as extracting agents. A preferred solvent is water. However, other solvents can also be used, for example alcohols, such as ethanol. Mixtures of solvents can also be used, such as mixtures of water and alcohol, in particular ethanol. To increase the degree of extraction, excipients can also be added to the extracting agent. Thus, when using water as extracting agent, for example the pH can be set by using for example a suitable buffer system, or also the salt concentration, for example by adding sodium chloride, with the result that the solubility of the vegetable proteins in water is increased and a premature denaturation is avoided. Preferably, the extracting agent, in particular water, is set to a pH>6, particularly preferably >7, in particular in a range of up to pH 9, in particular preferably in a range of up to 8. If the extracting agent contains a salt, the concentration of the salt is preferably set such that a 0.1 to 3 molar, preferably 0.5 to 2.5 molar, particularly preferably 1 to 2 molar solution of the salt is obtained in the extracting agent.

The quantity of the inorganic adsorber material is preferably chosen small so as to suppress an unwanted adsorption of vegetable proteins on the inorganic adsorber material. Preferably, a quantity of at least 0.5 wt. -%, particularly preferably at least 1 wt. -%, relative to the weight of the vegetable raw material, is sufficient to achieve a satisfactory elimination of unwanted accompanying substances from, the vegetable protein extract. Quantities of inorganic adsorber material which are too large should not be used. Preferably, the quantity of the inorganic adsorber material is chosen smaller than 20 wt. -%, preferably smaller than 10 wt. -%, relative to the weight of the vegetable raw material.

The vegetable protein extract is preferably at a dry mass in the range of from 0.1 to 50 wt. -%, particularly preferably 1 to 40 wt. -%, in particular preferably 2 to 30 wt. -%. The dry mass is relative to the constituents dissolved in the vegetable protein extract.

The protein concentrates obtained with the method according to the invention are clearly more sensory-neutral than protein concentrates prepared without adsorption of unwelcome accompanying substances on inorganic adsorber materials. For example, soya protein extracts treated with inorganic adsorber materials have been evaluated significantly less as bitter, bean-like and grassy/green in sensory evaluation compared with vegetable protein extracts which had not undergone absorptive treatment. In addition, rapeseed protein which was practically free from sinapine and still contained sinapinic acid only in low concentration was able to be prepared by the above-named treatment with inorganic adsorber materials.

The inorganic adsorber material can be added to the vegetable protein extract while this still contains the vegetable raw material. However, a simultaneous depletion of vegetable proteins in the vegetable protein extract or a clear adsorption of the vegetable proteins on the inorganic adsorber material was observed with some applications. Preferably, the method according to the invention is therefore carried out in such a way that insoluble constituents are eliminated from the vegetable protein extract. The elimination of the insoluble constituents which in particular go back to the vegetable raw material can take place with usual methods, for example by centrifuging, filtering or pouring away the vegetable protein extract, with the result that the insoluble constituents of the vegetable raw material remain behind.

The inorganic adsorber material added to the vegetable protein extract to separate out unwanted accompanying substances can remain in the vegetable protein extract. This is possible for example if the vegetable protein extract is used to prepare animal feeds. According to an embodiment of the method according to the invention, however, the inorganic adsorber material is separated from the vegetable protein extract. Usual methods, such as centrifugation, filtration or decanting, can be used for the separation.

The vegetable protein extract, can be used as such, i.e. in the form of a solution, obtained with the method, of the vegetable proteins in the extracting agent. Optionally, the protein content can be set to a desired level by adding or removing solvent, in particular water.

According to an embodiment, the vegetable protein can however also be separated from the vegetable protein extract. Usual methods can likewise be used for this. For example, the extracting agent, in particular water, can be distilled off or eliminated by freeze-drying or spray-drying. However, it is also possible to precipitate the protein out or to adsorb it on a suitable further carrier and then separate it from the extracting agent using usual methods.

According to preferred embodiments, the above-described method according to the invention comprises one or more steps selected from the group of:
i. separating insoluble constituents of the vegetable raw material from the vegetable protein extract;
ii. separating the inorganic adsorber material from the vegetable protein extract;
iii. separating vegetable protein from the vegetable protein extract;
iv. decomposing the vegetable raw material, in particular by shelling, grinding and/or flaking;
v. pre-extracting the vegetable raw material, preferably one to six times, particularly preferably one to three times,
   preferably in 5 to 10 times the quantity of water at acid pH values, further preferably close to the isoelectric point, particularly preferably at pH ≦5, and/or
   preferably at cold temperatures, particularly preferably at temperatures ≦10° C.,
   and separating the solid from the liquid phase after each pre-extraction step;
vi. repeating the addition of the inorganic adsorber material to the vegetable protein extract several times, preferably one to three times;
vii. neutralizing the precipitated protein concentrate.

Through the decomposition of the vegetable raw materials, the vegetable proteins contained in these are more easily accessible and can therefore be more easily dissolved out of the vegetable raw material. When the vegetable raw materials are being decomposed, their structure is destroyed or damaged and their ceils are also at least partially broken open. In the simplest case, the decomposition of the vegetable raw material can comprise for example the shelling of vegetable seeds. However, the vegetable raw material can also be squeezed or pressed. Furthermore, it is also possible to grind the vegetable raw material, with the result that a powder is obtained which has a large surface area from which the desired vegetable protein can then be dissolved out of the extracting agent. However, it is also possible to break the vegetable raw material into larger fragments. The aim of this process is to make the vegetable protein contained in the decomposed vegetable raw material more accessible for the extracting agent.

To eliminate a proportion of the unwelcome accompanying substances from the vegetable raw material even before carrying out the method according to the invention, the vegetable raw material can also be pre-extracted according to an embodiment of the method. The same extracting agent can be used for the pre-extraction as for the preparation of the vegetable protein extract used in the method according to the invention. However, it is also possible to use a different extracting agent. For example, for the pre-extraction an aqueous extracting agent can be used which is set to a different pH from the aqueous extracting agent used for the preparation of the vegetable protein extract. For the pre-extraction, conditions are preferably used in which the vegetable protein is co-extracted only to a small extent. Thus preferably only a small quantity of extracting agent is used, preferably 5 to 10 times the quantity of water, relative to the weight of the vegetable raw material. The pre-extraction is preferably carried out using an aqueous extracting agent which has an acid pH, particularly preferably a pH of ≦5. In particular, the extracting agent, used for the pre-extraction is set to a pH which lies close to the isoelectric point of the vegetable protein. Furthermore, the pre-extraction is preferably carried out at cold temperatures at which the solubility of the vegetable protein is low. The chosen temperature is preferably ≦10° C. If the pre-extraction is repeated several times, the vegetable raw material is preferably separated from the extracting agent after each pre-extraction, with the result that the next pre-extraction can be carried out with fresh extracting agent.

The separating-out of the unwanted accompanying substances can be repeated once or several times. For this, the inorganic adsorber material is preferably separated in each case from the vegetable protein extract and fresh inorganic adsorber material is then added to the vegetable protein extract.

If the vegetable protein has been precipitated out of the vegetable protein extract, this can also be neutralized according to an embodiment, for example by adding acid or lye.

In one embodiment, the method according to the invention contains at least one of the following steps:
1. the vegetable protein extract is set to a pH in the range of from 3-10, preferably 5-9, further preferably ≧6 and particularly preferably 6-8;
2. the separating-out of the inorganic adsorber material takes place mechanically, in particular by centrifugation or filtration;
3. the concentration of the inorganic adsorber material is 0.1-20 wt. -%, preferably 0.1-10 wt. -%, further preferably 0.5-5 wt. -%, relative to the weight of the vegetable raw material used;
4. the separating-out of the inorganic adsorber material cakes place mechanically, in particular by centrifugation or decanting; and/or
5. the separating-out of the protein takes place by
   i) precipitation of the dissolved protein out of the solution, preferably close to the isoelectric point of the vegetable protein, particularly preferably at a pH<7;
   ii) solid/liquid separation of the precipitated protein from the supernatant;
   iii) drying of the vegetable protein extract, preferably spray drying.

The adsorber materials can be disposed of in an environmentally friendly manner. They can foe composted as bio-waste in usual manner or used for example as fertilizer or to prepare biogas.

As already explained, any vegetable raw materials per se can be used in the method according to the invention. For example oilseeds, pressing residues of oil production, legumes and all other protein-containing vegetable raw materials can be used as raw materials. Protein-rich vegetable raw materials which contain >10 wt. -%, better >20 wt. -%, preferably >30 wt. -% vegetable protein, relative to the dry mass of the vegetable raw material, are particularly advantageous.

The unwanted accompanying substances contained in the vegetable protein extract often represent a mixture of different compounds which are also chemically different in nature. The method according to the invention is suitable in particular for eliminating water-soluble unwelcome accompanying substances, particularly fragrance, flavour and/or colour components. Because of their water-solubility, the unwelcome accompanying substances can foe dissolved out of the matrix formed by the. vegetable protein and then, sometimes already in low concentration, impair the fragrance, the flavour or the colour of a food or animal feed into which a vegetable protein concentrate obtained from the vegetable protein extract is worked. According to an embodiment, the unwanted accompanying substances, particularly fragrance, flavour and/or colour components, are selected from the group of polyphenols, particularly preferably hydroxycinnamic acids, such as in particular caffeic acid and sinapinic acid, as well as their derivatives, such as sinapine and chlorogenic acid.

The inorganic adsorber material used in the method according to the invention influences the selectivity of the separating-out of the unwanted accompanying substances. According to an embodiment of the method according to the invention, the inorganic adsorber material is selected from the group of clays, in particular from the group consisting of synthetic clays and clays of natural origin, such as clay minerals.

The clays preferably used within the framework of the invention to clean up the vegetable proteins can carry anionic charges or cationic charges or also be uncharged. The selection of the clay is based on the vegetable raw material and the properties of the unwelcome accompanying substances to be separated out, particularly fragrance, flavour and/or colour components. The clays can be of synthetic or natural origin. As a rule, clay minerals of natural origin are preferred on the grounds of the costs and the high availability. Examples of synthetic clays which can be used in the method according to the invention are the so-called cationic clays, such as e.g. hydrotalcites.

The anionic clays which can be used according to the invention include in particular smectite clays as well as vermiculites. These include the charged clay minerals of 2:1 layer type with a negative charge of 0.2-0.6 per formula unit. Examples of smectites are bentonite, montmorillonite, beidellite, nontronite, hectorite and saponite. A further suitable smectite is stevensite, the structure of which can be derived from that of talc by Mg²⁺ ion vacancies.

Typical smectites are for example bentonites, the active mineral of which is montmorillonite. Such bentonites typically have a cation exchange capacity of between 50 and 120 meq/100 g and display a great swelling capacity in water.

In an embodiment according to the invention, the inorganic adsorber material contains stevensite or a stevensite phase.

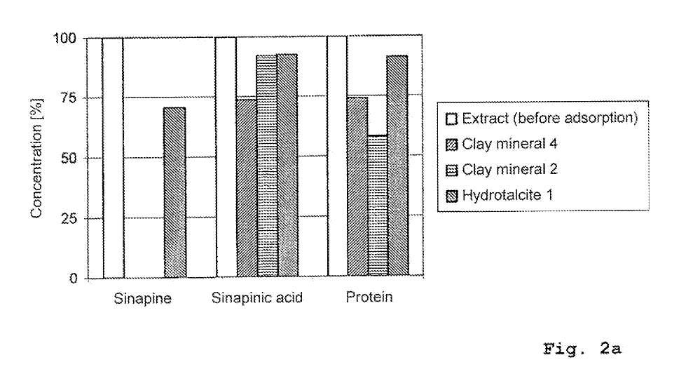

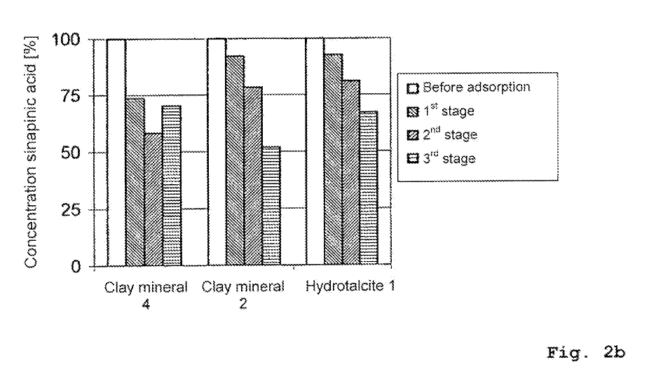

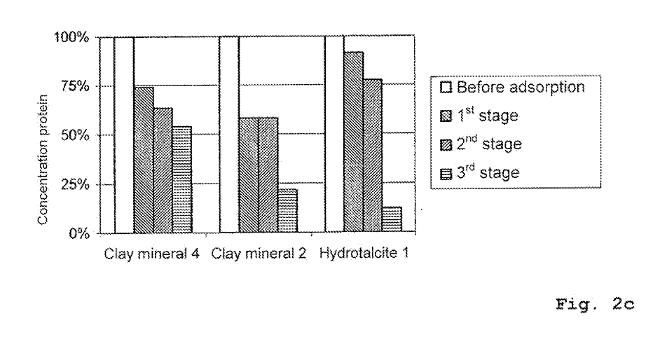

A person skilled in the art is familiar with what is meant by stevensite. A more detailed characterization of stevensite is found for example in J. L. Martin de Vidales et al., Clay Minerals, 1991, 26, 329-342, and in G. B. Brindley et al., Mineralogical Magazine, 1977, 41, 443-452, to which express reference can be made. The determination of stevensite can be carried out as described there. The diffraction peak at lattice spacing (basal spacing) 10 Å, the position of which at different humidities displays a clear shift, is characteristic. The spacing close to 17 Å during treatment with ethylene glycol is also characteristic. Express reference is here made to the powder X-ray diffractograms for stevensite given in G. B, Brindley et al., Mineralogical Magazine, 1977, 41, 443-452 in FIG. 2 and the associated parts of the text. According to the invention, the position of the diffraction peak at a lattice spacing of approximately 10 Å therefore changes characteristically in the case of the stevensites used or in the stevensite-containing components at different humidities or during a treatment with ethylene glycol according to FIG. 2 in G. B. Brindley et al., Mineralogical Magazine, 1977, 41, 443-452. The stevensite used thus also differs for example from pure cerolite.

The expression “stevensite” also covers stevensite-containing components here, for the sake of simplicity. The term “stevensite-containing component” is intended to express the fact that according to the invention inorganic adsorber materials can also be used which, in addition to stevensite, also contain further constituents. For example, many commercially available stevensite products also contain various quantities of accompanying minerals in addition to stevensite. In addition, mixtures of stevensite with other constituents, such as for example other mineral constituents, in particular sheet silicates, are also conceivable.

According to an embodiment of the invention, at least one stevensite- and/or cerolite-containing component is used which consists substantially or entirely of stevensite or at least one stevensite-containing component.

In a further preferred embodiment, the inorganic adsorber material contains a saponite. The definition of the typical mineral saponite can be consulted inter alia in “Developments in Clay Science 1: Handbook of Clay Science”, F. Bereave, B. K. G. Theng, G. Lagaly (Eds.), Elsevier, Amsterdam 2006, and herein in particular Chapter 1, “General Introduction: Clays, Clay .Minerals and Clay Science”, F. Bergaya and G. Lagaly, p. 1 ff. Saponite is a trioctahedral smectite with magnesium ions in the octahedral layer. The negative charge of this smectite clay mineral is due to the replacement of some of the silicon atoms in the tetrahedral layer by aluminium ions. As it is derived from talc, saponite can be considered as well as stevensite. Saponites usually also have relatively low cation exchange capacities and typically BET surface areas of more than 800 m²/g.

The selection of preferred smectite clay minerals is based on the unwanted accompanying substances to be separated out. If the component to be separated out contains for example amino groups or in particular quaternary ammonium groups, almost ail smectite minerals are suitable, because their surface area has a strong affinity to amino and ammonium groups. In particular, bentonites or montmorillonites are also suitable here. An example of this is the elimination of the phenolic acid derivative sinapine, which is a quaternary ammonium compound, from raw rapeseed protein preparations.

If inappropriate fragrances are to be eliminated in general, the less charged smectitic layered silicates, such as e.g. saponites or stevensites, are preferably used, because many of these fragrances are molecules with larger hydrophobic components.

In a further embodiment according to the invention, the inorganic adsorber material used contains uncharged clays, such as cerolite-containing materials and minerals of the talc group, such as in particular talc, chlorite. Such clays can be used for example to eliminate inappropriate fragrances from pea protein, soya protein or lupin protein.

A person skilled in the art is familiar with what is meant by cerolite and need not be explained in more detail here. For example reference can also be made here to G. B. Brindley et al., Mineralogical Magazine, 1977, 41, 443-452. The determination of cerolite can be carried out as described there. The chemical analysis of cerolite produces a composition close to R₃Si₄O₁₀(OH₂.H₂O, wherein R mainly represents Mg and n is approximately 0.8 to 1.2. The diffraction peak at lattice spacing (basal spacing) 10 Å, the position of which displays no expansion at different humidities and no thermal contraction up to 500° C., is characteristic. Express reference is here made to the powder X-ray diffractograms for cerolite given in G. B. Brindley et al., Mineralogical Magazine, 1977, 41, 443-452 in FIG. 2 and the associated parts of the text.

The expression “cerolite” also covers cerolite-containing components here, for the sake of simplicity. The term “cerolite-containing component” is intended to express the face that according to the invention inorganic adsorber materials can also be used which, in addition to cerolite, also contain further constituents. For example, many commercially available cerolite products also contain various quantities of accompanying minerals in addition to cerolite. In addition, mixtures of cerolite with other constituents, such as for example other mineral constituents, in particular sheet silicates, are also conceivable.

Cerolite is often found in nature accompanied by related minerals, in particular from the group of smectites and in particular by stevensites or saponites. Stevensites or saponites can also be represented as a modification of cerolite. Thus, stevensite forms from cerolite if some of the octahedral positions which are occupied by magnesium ions remain empty. Saponite forms by substitution of Si⁴⁺ positions with Al³⁺.

According to an embodiment of the invention, at least one stevensite- and/or cerolite-containing component which consists substantially or entirely of cerolite or at least one cerolite-containing component is used as inorganic adsorber material.

According to a further embodiment of the invention, the component used, contains both stevensite or a stevensite phase and cerolite or a cerolite phase. It was found that such stevensite- and cerolite-containing components display particularly good bonding properties for the unwanted accompanying substances contained in vegetable protein extracts.

According to a preferred embodiment, the stevensite- and/or cerolite-containing component used as inorganic adsorber material contains at least 10 wt. -%, preferably at least 50 wt. -%, in particular at least 75 wt. -%, particularly preferably at least 90 wt. -%, in particular preferably at least 35 wt. -%, stevensite and/or cerolite. Thus it was surprisingly found that a particularly good contaminant bond results when stevensite and/or cerolite mineralogically represents the main phase in the components used according to the invention.

Within the framework of the present invention, it was furthermore found that particularly those stevensite- and/or cerolite-containing components that have a magnesium oxide content of at least 15 wt. -%, in particular at least 17 wt. -%, further preferably at least 20 wt. -%, are suitable as Inorganic adsorber-material. Corresponding materials are commercially available. Furthermore, it is preferred that, the magnesium oxide content of the stevensite- and/or cerolite-containing components used, in particular of the stevensite or stevensite-containing component, is not more than 40 wt. -%, in particular not more than 35 wt. -%, in many cases further preferably not more than 32 wt. -%.

The magnesium oxide content is also decisive for the accurate formation of the sheet structure of the material. It is assumed, without the invention being limited to the correctness of this assumption, that the sheet structure of the inorganic adsorber material used according to the invention, in particular of the stevensite, provides a particularly favourable porosimetry and particularly efficient surfaces for adsorbing a large number of different unwanted accompanying substances.

According to an embodiment of the invention, in particular in the case of components with a high proportion of stevensite, the BET surface area (measured according to DIN 66131, see method part) is preferably at least 60 m²/g, in particular at least 80 m²/g, in particular at least 100 m²/g. These high BET surface areas obviously make possible an even more efficient adsorption of some unwanted accompanying substances.

Furthermore, in a particularly preferred embodiment, the cerolite can be accompanied by saponite.

It was furthermore found that particularly those components that have a cation exchange capacity (CSC) of less than 40 meq/100 g, in particular less than 35 meq/100 g, particularly preferably less than 30 meq/100 g, deliver particularly good results. The CEC can be determined as described in the method part below.

According to a further preferred embodiment, those stevensite- and/or cerolite- and/or saponite-containing components that have a CEC of at least 2 meq/100 g, preferably at least 5 meq/100 g, in particular at least 10 meq/100 g, further preferably at least 15 meq/100 g, are used.

The uncharged systems, such as cerolite, and also charged systems, such as saponite, are suitable in particular for eliminating hydrophobic unwelcome accompanying substances from the vegetable protein extract.

If the unwanted accompanying substances contained in the vegetable protein carry negative charges, cationic clays are particularly preferably used for the clean-up. These are in particular layered double hydroxides and preferably so-called hydrotalcites.

The layered double hydroxides used according to the invention are thus preferably selected from the group consisting of natural and synthetic hydrotalcites and compounds with a hydrotalcite-like structure. A person skilled in the art is familiar with what is meant by hydrotalcites and compounds with a hydrotalcite-like structure. According to a preferred embodiment, as long as the ratio of M²⁺ to N³⁺ explained below is observed, a layered double hydroxide selected from the group of natural and synthetic hydrotalcites and hydrotalcite-like compounds can be used, such as are described for example in the literature reference Catalysis Today, Vol. 11 (No. 2) of 2^{nd} December 1991, pages 173 to 301 (“hydrotalcite-like compounds”). Such compounds have a hydrotalcite-like structure.

To prepare the hydrotalcites or the compounds with a hydrotalcite-like structure, in principle any method familiar to a person skilled in the art can be used, such as is described for example in the above literature reference Catalysis Today (op. cit.) on pages 173 to 301, in particular 201 to 212, in DE 20 61 114, U.S. Pat. Nos. 5,399,323 and 5,573,286, DE 101 19 233 or WO 01/12570 and also in “Handbook of Clay Science”, F. Bergaya, B. K. G. Theng and G. Legaly (Eds.), Developments in Clay Science, Vol. 1, Chapter 13.1, Layered Double Hydroxides, C. Forano, T. Hibino, F. Leroux, C. Taviot-Gueho, Handbook of Clay Science, 2006.

Particularly preferably, a layered double hydroxide (LDH) of the general empirical formula

[M₁₋ₓ²⁺Nₓ³⁺ (OH)₂]^{x+}[Aⁿ⁻]_{x/n}·yH₂O

is used, wherein M²⁺ represents at least a divalent metal ion and N³⁺ at least a trivalent metal ion, Aⁿ⁻ stands for at least one anion, x a rational number between 0 and 1, n a positive number and y a positive number including 0.

In general, any divalent metal ion suitable for layered double hydroxides and familiar to a person skilled in the art or a combination of two or more such metal ions can be used as M²⁺. In particular, M²⁺ represents one or more from the group of Mg²⁺, Ca²⁺, Zn²⁺, Mn²⁺, Co²⁺, Ni²⁺, Fe²⁺, Sr²⁺, Ba²⁺ and/or Cu²⁺.

In general, any trivalent cation suitable for layered double hydroxides and familiar to a person skilled in the art or a combination of two or more such cations can be used as N³⁺. In particular, N³⁺ represents one or more trivalent cations from the group of Al³⁺, Mn³⁺, Co³⁺, Ni³⁺, Cr³⁺, Fe³⁺, Ga³⁺, Sc³⁺, B³⁺ and/or trivalent cations of rare earth metals.

According to a particularly advantageous embodiment of the invention, M²⁺ is magnesium and N³⁺ aluminium.

Those layered double hydroxides (LDHs) that also contain univalent cations, such as e.g. Li⁺, which can partially or wholly replace the divalent cations, can also be used according to the invention. Thus, layered double hydroxides with univalent cations are also covered by the present invention.

According to a particularly advantageous embodiment of the invention, the layered double hydroxide is a hydrotalcite the general empirical formula of which lies between [Mg₂Al(OH)₆](CO₃)_{0.5} and [Mg_{0.28}Al_{0.72}(OH)₂](CO₃)_{0.72}.

It was also found according to an advantageous embodiment that materials which, in addition to a hydrotalcite phase, also have a boehmite phase are particularly well suited. Such, a boehmite phase frequently occurs with high aluminium contents of the hydrotalcites. However, according to the invention, a mixture of a hydrotalcite and a boehmite can also be prepared and used. Thus both mixed, phases and mixtures of materials with hydrotalcite phase and materials with boehmite phase can be used. Preferably, the hydrotalcite proportion is 55 wt. -% or more.

The layered double hydroxides used according to the invention are preferably present, in uncalcined form. By calcining is meant in particular a temperature treatment in which the double-layered structure is wholly or partially lost. According to a preferred embodiment, the layered double hydroxide is regarded as uncalcined if it has not undergone a temperature treatment at more than approximately 500° C., in particular more than 450° C., in particular more than 350° C., in particular more than 250° C., in particular more than 150° C.

The inter layer anion Aⁿ⁻ is preferably selected from the. group consisting of carbonate, nitrate, halide, sulphate and phosphate or their mixtures, wherein n is a positive whole number. Particularly preferably, Aⁿ⁻ (see empirical formula above) is carbonate or the layered double hydroxide is present In carbonate form, wherein preferably at least 50%, more preferably at least 75% and in particular preferably at least 90% of the interlayer anions Aⁿ⁻ are carbonate ions.

The layered double hydroxide used here has the further advantage that it is stable in air and thus can be easily stored.

The layered double hydroxides used according to the invention can bond anionic impurities in quantities that are interesting for technical use.

The layered double hydroxide used in the method according to the invention preferably has a BET surface area of more than 15 m²/g, further preferably more than 20 m²/g, particularly preferably more than 55 m²/g, preferably of more than 65 m²/g, and further preferably also a pore volume of more than 0.30 ml/g, particularly preferably of more than 0.4 ml/g, in particular preferably in the range of from 0.45-0.6 ml/g (determined according to the BJH method (cumulative pore volume for pores with a diameter in the range of from 1.7 to 300 nm)).

According to a preferred embodiment of the invention, the layered double hydroxide has an average pore diameter of more than approximately 10 nm.

Particularly preferably, inorganic adsorber materials the particles of which have a diameter between approximately 0.5 to 100 μm, particularly preferably between 1 and 80 μm, in particular preferably between 4 and 60 μm, are used according to the invention. According to another preferred embodiment, the inorganic adsorber material is present in the form of a granular material which preferably has an average particle size of 0.08-2.5 mm.

According to an embodiment of the method according to the invention, the inorganic adsorber material, in particular the layered double hydroxide, can be equilibrated to a pH of from 5.0 to 10.0, in particular preferably from 6.0 to 9.0, before being added to the vegetable protein extract. For this, the inorganic adsorber material, in particular the layered double hydroxide, is suspended in a suitable buffer or a filter pack prepared from the inorganic adsorber material, in particular the layered double hydroxide, is exposed to the action of such a buffer. The concentration of the buffer is preferably between 30 to 100 mmol/l.

The hydrotalcites are very suitable for example for eliminating chlorogenic acid from sunflower protein preparations.

In individual cases, the unwanted accompanying substances eliminated by the inorganic adsorber materials used according to the invention are compounds which can be used as food additives, because positive health effects on the human organism can be accommodated. Examples of this are chlorogenic acid and caffeic acid, such as can be obtained e.g. from raw sunflower protein solutions.

It may therefore be expedient to recover the unwanted accompanying substances separated from the vegetable protein extract from the inorganic adsorber materials used. This is possible for example with the used clays by means of various method variants: for example an extraction with solvents, such as e.g. ethanol or acetone, can be used. If the chlorogenic acid bonded to hydrotalcites is to be recovered, this can foe achieved for example with a phosphate buffer.

The use of certain layered double hydroxides as anion exchangers or adsorbents is known from the state of the art. Hydrotalcite is often used in the activated calcined form. During the calcination, hydrotalcite is treated for several hours at 600° C., wherein water and carbon dioxide escape. The calcined hydrotalcites have base, properties and are very heat-stable. However, they are very sensitive to carbon dioxide and atmospheric humidity. Thus, the calcined hydrotalcites would have to foe stored with air excluded, which is not suitable for industrial-scale applications.

It was found that the hydrotalcites can be used in particular for depleting anionic minor constituents in the vegetable protein preparations. An example of this is the elimination of sinapinic acid from rapeseed protein preparations.

A further subject of the invention relates to the use of clays for eliminating unwanted accompanying substances, particularly fragrance, flavour and/or colour components from vegetable protein extracts. Suitable clays have already been discussed in more detail above.

As already explained in the method according to the invention, the unwanted accompanying substances, particularly fragrance, flavour and/or colour components, are preferably selected from the group of polyphenols, particularly preferably hydroxycinnaraic acids, such as in particular caffeic acid and sinapinic acid, as well as their derivatives, such as sinapine, and chlorogenic acid.

The invention is explained in more detail below using examples as well as with reference to the enclosed figures. There are shown in:

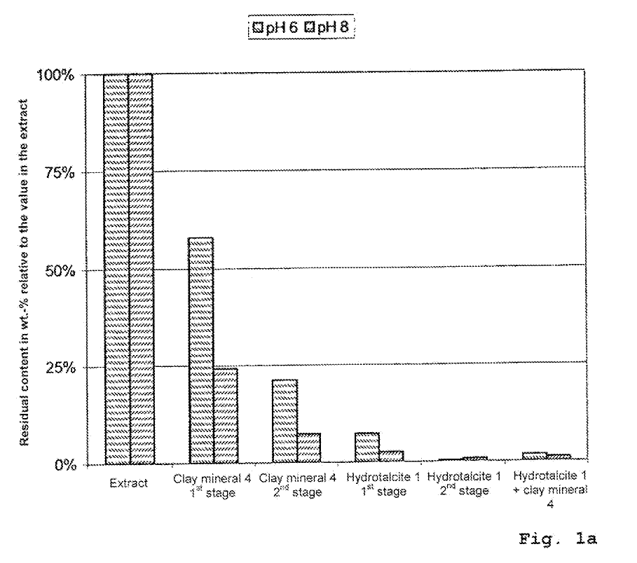

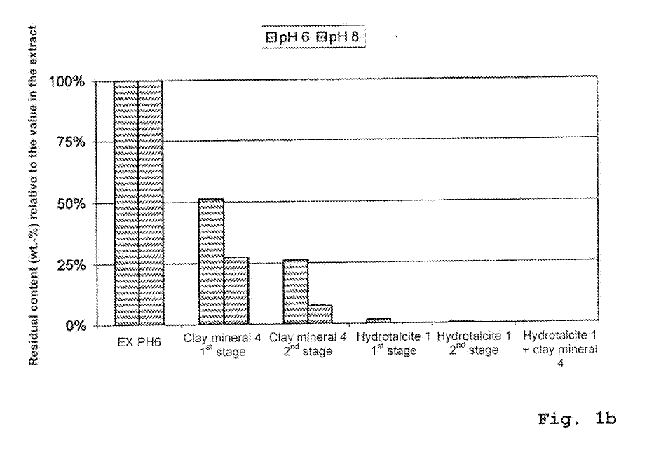

FIG. 1a: a representation of the proportions of chlorogenic acid in a sunflower protein extract after treatment with an inorganic adsorber material; the percentage proportion of the chlorogenic acid is in each case relative to the chlorogenic acid concentration of the uncleaned extract (100%);

FIG. 1b: a representation of the proportions of caffeic acid in a sunflower protein extract after treatment with an inorganic adsorber material; the percentage proportion of the caffeic acid is in each case relative to the chlorogenic acid concentration of the uncleaned extract (100%);

FIG. 2a; Elimination of sinapine and sinapinic acid from a rapeseed protein extract by a single treatment with an inorganic adsorber material (1 wt. -%); the percentage proportions of sinapine and sinapinic acid are relative to the uncleaned. rapeseed protein extract (100%);

FIG. 2b: Elimination of sinapine and sinapinic acid from a rapeseed protein extract by repeated treatment with an inorganic adsorber material (1 wt. -%); the percentage proportions of sinapine and sinapinic acid are relative to the uncleaned rapeseed protein extract (100%);

FIG. 2c: Elimination of rapeseed protein from a rapeseed protein extract by repeated treatment with an inorganic adsorber material (1 wt. -%); the percentage proportions of rapeseed protein are relative to the uncleaned rapeseed protein extract (100%);

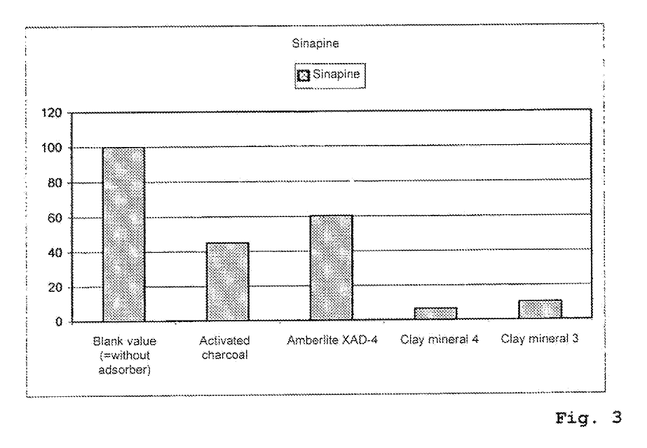

FIG. 3: Elimination of sinapine and sinapinic acid from a rapeseed protein extract by a single treatment with different adsorber materials (1 wt. -%); the percentage proportions of sinapine and sinapinic acid are relative to the uncleaned rapeseed protein extract (100%).

### EXAMPLES

### General Methods

### BET Surface Area/pore Volume According to BJH and BET:

The surface area and the pore volume were determined with a fully automatic Micromeritics ASAP 2010 nitrogen porosimeter.

The sample is cooled in high vacuum to the temperature of liquid nitrogen. Nitrogen is then continuously introduced in metered doses into the sample chamber. An adsorption isotherm is calculated at constant temperature by recording the adsorbed quantity of gas as a function of the pressure. After a pressure equalization, the analysis gas is progressively removed and a desorption isotherm is plotted.

To ascertain the specific surface area and the porosity according to the BET theory, the data are evaluated according to DIN 66131.

The pore volume is furthermore calculated from the measurement data applying the BJH method (E. P. Barret, L. G. Joiner, P. P. Haienda, J. Am. Chem. Soc, 73 (1951, 373)). Capillary condensation effects are also taken into account with this method. Pore volumes of specific pore size ranges are determined by totalling incremental pore volumes which are obtained from the evaluation of the adsorption isotherm according to BJH. The total pore volume according to the BJH method relates to pores with a diameter of 1.7 to 300 nm.

### Particle Size Determination by Means of Dynamic Light Scattering (Malvern):

The measurements are carried out with a “Mastersizer” device from Malvern Instruments Ltd., UK, in accordance with the manufacturer's instructions. The measurements are carried out in air with the provided sample chamber (“dry powder feeder”) and the values relative to the sample volume are ascertained.

### Water Content:

The water content of the products at 105° C. is ascertained using the DIN/ISO-787/2 method.

### Elemental Analysis:

This analysis is based on the total decomposition of the clay materials or corresponding product. After the dissolution of the solids, the individual components are analyzed using conventional specific analysis methods, such as e.g. ICP, and quantified.

### Ion Exchange Capacity (Only for Anionic Layered Minerals):

To determine the cation exchange capacity, the clay material to be examined is dried over a period of 2 hours at 105° C. The dried clay material is then reacted with an excess of aqueous 2N NH₄Cl solution for 1 hour at reflux. After a standing time of 16 hours at room temperature, the mixture is filtered, whereupon the filter cake is washed, dried and ground and the NH₄ content in the clay material is ascertained by nitrogen determination (“Vario EL III” CHN analyser from Elementar, Hanau) in accordance with the manufacturer's instructions. The proportion and the type of the exchanged metal ions are determined in the filtrate by ICP spectroscopy.

### Determination of the Montmorillonite Content via Methylene Blue Adsorption

The methylene blue value is a measure of the internal surface area of clay materials.

a) Preparation of a tetrasodium diphosphate solution:

5.41 g tetrasodium diphosphate is weighed, out accurately to within 0.001 g into a 1000-ml measuring flask and, accompanied by shaking, filled up with dist. water as far as the calibration mark.

b) Preparation of a 0.5% methylene blue solution:

In a 2000 ml beaker, 125 g methylene blue is dissolved in approx. 1500 ml dist. water. The solution is decanted and made up to 25 l with dist. water.

0.5 g moist test bentonite with a known internal surface area is weighed out accurately to within 0.001 g in an Erlenmeyer flask. 50 ml tetrasodium diphosphate solution is added and the mixture is heated for 5 minutes until it boils. After cooling to room temperature, 10 ml 0.5 molar H₂SO₄ is added and 80 to 95% of the expected final consumption of methylene blue solution is added. A drop of the suspension is taken up with the glass rod and placed onto a filter paper. A blue-black spot with a colourless corona forms. Further methylene blue solution is now added, in portions of 1 ml and the spot test repeated. The addition continues until the corona turns a slightly light blue colour, i.e. the added quantity of methylene blue is no longer absorbed by the test bentonite.

c) Testing of clay materials:

The clay material is tested in the same manner as the test bentonite. The internal surface area of the clay material can be calculated from the consumed quantity of methylene blue solution.

381 rag methylene blue/g clay corresponds according to this method to a 100% montmorillonite content.

Determination of the Dry Sieving Residue:

About 50 g of the air-dry clay material to be examined is weighed out onto a sieve of the appropriate mesh size. The sieve is connected to a vacuum cleaner which sucks out. through the sieve ail of the portions which are finer than the sieve, via a suction slit rotating beneath the sieve bottom. The sieve is covered with a plastic lid and the vacuum cleaner is switched on. After 5 minutes, the vacuum cleaner is switched off and the quantity of coarser portions remaining on the sieve is ascertained by difference weighing.

Quantitative Determination of Phenolic Acid in Aqueous Solutions:

The concentrations of the phenolic acids (chlorogenic acid, sinapine) were determined by UV spectroscopy. The procedure was according to the instructions, as described in “Thiyam U., Stöckmann H., Schwarz K. Antioxidant Activity of Rapeseed Phenolics and Their Interactions with Tocopherols During Lipid Oxidation JAOCS, Vol. 83, No. 6 (2006)”.

Preparation of the Protein Extracts

Extraction from Rapeseed

100 g de-oiled coarse rapeseed meal was suspended in 1 litre cold de-ionized water (5° C. and stirred for 30 minutes. After 10 minutes of centrifugation at 4000 g, the supernatant was separated out. The pellet was used for the following protein extraction. For this, a quantity of water which equalled the quantity of liquid that had previously been separated out was added. The batch was heated to 40° C., set to the respective pH (7.4 or 8.0) and stirred for 45 min. After 15 minutes of centrifugation at 4000 g, the supernatant was separated from the pellet. The supernatant (=vegetable protein extract) was used for the tests for adsorbing unwanted accompanying substances on inorganic adsorber materials.

Extraction from Coarse Sunflower Meal

100 g de-oiled coarse sunflower meal was suspended in 1 litre tap water. The pH was sec to 5 by means of hydrochloric acid and the batch was thoroughly mixed for 5 minutes by means of Ultra-Turrax®. After 20 minutes of centrifugation at 4000 g and 15° C., the supernatant was separated out. The pellet was used for the following protein extraction. For this, a quantity of 1.5 M salt solution which equalled the quantity of liquid previously separated out was added. The pH was set to 6 or 8 and the batch was stirred for 60 min. After 20 minutes of centrifugation at 4000 g and 15° C., the supernatant was separated, from the pellet. The supernatant (=vegetable protein extract) was used for the tests for adsorbing unwanted accompanying substances on inorganic adsorber materials.

Extraction from Coarse Soya Meal and Pea Meal

100 g de-oiled coarse soya meal or 100 g pea meal was mixed, with 1 litre tap water. After setting the pH to 4.5 (by means of hydrochloric acid), the batch was stirred for 60 minutes at room temperature. After 10 minutes of centrifugation at 3000 g, the supernatant was separated out. The pellet, was used for the following protein extraction. For this, a quantity of tap water which equalled the quantity of liquid that had previously been separated out was added to the pellet. The appropriate pH was set and the mixture stirred for 60 min. After 10 minutes of centrifugation at 3000 g, the supernatant was separated from the pellet. The supernatant vegetable protein extract) was used for the tests for adsorbing unwanted accompanying substances on inorganic adsorber materials.

Procedure When Extracting from Vegetable Raw Material Without Pre-extraction

In tests without pre-extraction, 100 g vegetable raw material was mixed directly with 1 litre tap water, the appropriate pH set and the mixture stirred for 60 min. After 10 minutes of centrifugation at 3000 g, the supernatant was separated from the pellet. The supernatant (=vegetable protein extract) was used for the tests for adsorbing unwanted accompanying substances on inorganic adsorber materials.

Adsorption on Inorganic Adsorber Material

The respective inorganic adsorber material was added in the corresponding concentrations (1 wt. -%, 2 wt. -% or 5 wt. -%, relative to the weight of the vegetable raw material used) to 100 ml of the protein extracts and the mixture was stirred for 30 minutes. The adsorber materials were separated out again by centrifugation. (3000 g, 10 min., 25° C.), Optionally, the obtained supernatant was subjected to one to two further adsorption stages.

The obtained extracts were the starting material for the analytical and sensory examinations.

Determination of the Protein Content in Solutions with Biuret Reaction

Principle

The biuret reaction serves to detect compounds which contain at least two CO—NH groups and is based, on a copper complex salt formation. This becomes visible through a red-violet colouration and can be ascertained quantitatively by measuring the absorbance at λ=550 nm.

Procedure

The protein solutions were diluted until the protein concentration was in the calibration range 1-10 mg/ml. In each case 2 ml biuret solution (*) was added to 0.5 ml of these solutions (sample or protein standard solution) and immediately mixed. These were then incubated for 20 min. at 37° C. in the water bath. After another 20 min. the absorbance of the individual samples in the spectrophotometer at λ=550 nm was measured,

(*) 6.0 g potassium sodium tartrate C₄H₄KNaO₆; 1.5 g copper sulphate CuSO₄·5 H₂O; 250 ml dist. water; 300 ml 1 M caustic soda solution

The protein concentration of the samples is calculated by dividing the absorbance of the individual protein extracts, including the dilution factor, by the conversion factor (pitch) from the calibration lines. The mean value is then formed from the three individual concentrations.

References

AACC Method 46-15: Crude Protein—5-Minute Biuret Method for Wheat and Other Grains, In: Approved Methods of the American Association of Cereal Chemists, edition no. 8, American Association of Cereal Chemists, Inc., St. Paul, Minn. USA, 1983.

Matissek, R., Schnepel, F. -M., Steiner, G. In: Lebensmittel-Analytik. Springer Verlag, Berlin, Tokyo, 1988.

Quantitative Determination of Phenolic Acids Using HPLC

The vegetable protein extracts prepared as described above served as starting material before and after the adsorption of unwanted accompanying substances on the inorganic adsorber material. 1 ml of the respective protein extract was mixed with 1 ml of 70% aqueous methanol. The concentration must lie in the range of the calibration lines of the substance to be determined. Otherwise, the protein extract was further diluted. The diluted sample was centrifuged and the supernatant measured in the HPLC,

Analysis Conditions
Column; Synergi® Fusion-RP, Phenomenex, size: 250 mm×4.6 mm 4 micron;
Operating software: Chromeleon (Chromatography Management Systems), Dionex;
Running time: 40 min.;
Mobile phase A: 90% H₂O; 10% MeOH; 0.2% o-phosphoric acid (85%);
Mobile phase B: 100% MeOH; 0.1% o-phosphoric acid;
Injection volume: 20 μl;
Flow rate: 0.8 ml/min.;
Temperature: Room temperature;
Detection: UV-Vis at 330 nm;
Gradient:

| Time intervals in min. | Eluent A in % | Eluent B % |
|---|---|---|
| From 0 to 7 | 90 | 10 |
| From 7 to 20 | 80 | 20 |
| From 20 to 25 | 55 | 45 |
| From 25 to 28 | 30 | 70 |
| From 28 to 40 | 0 | 100 |

Quantification took place by means of a calibration line which was set by the respective standard substances which are measured in different concentrations. The surfaces of the previously identified peak were converted into concentrations with the aid of the calibration lines.

References:

Thiyam, U., Stockmann, H., Schwarz, K. Antioxidant activity of rapeseed phenolics and their interactions with tocopherols during lipid oxidation. JAOCS 83 (65, 2006, 523-528.

### Example 1

### Characterisation of the Inorganic Adsorber Materials

The characterization data of the materials according to the invention are listed in Table 1.

TABLE 1
Characterization of inorganic adsorber materials

| | Clay min. 1 | | Clay | | Hydrotalcite 1 |
|---|---|---|---|---|---|
| Parameter | Calcigel | Clay min. 2 | min. 3 | Clay min. 4 | Synthal 696 |
| Mineral | Ca | Soda-activated | Saponite | Cerolite/ | Hydrotalcite |
| phase | bentonite | bentonite | | smectite | in carbonate |
| | | | | | form |
| BET surface | 65.5 | n.d. | 125.3 | 224.2 | 61.4 |
| area [m²/g] | | | | | |
| Micropore | 64.9 | n.d. | 56.6 | 113 | 4.7 |
| surface area | | | | | |
| [m²/g] | | | | | |
| External | 39.3 | n.d. | 80.8 | 147 | 56.7 |
| surface area | | | | | |
| [m²/g] | | | | | |
| Cumulative | 0.10 | n.d. | 0.16 | 0.22 | 0.482 |
| pore volume | | | | | |
| according to | | | | | |
| BJH for pores | | | | | |
| with | | | | | |
| diameters of | | | | | |
| 1.7 to | | | | | |
| 300 nm, | | | | | |
| [cm³/g] | | | | | |
| Average pore | 6.5 | n.d. | 5.2 | 4.8 | 24.6 |
| diameter | | | | | |
| [4 V/A] | | | | | |
| according to | | | | | |
| BET [nm] | | | | | |
| Average pore | 9.6 | n.d. | 7.2 | 6.6 | 30.0 |
| diameter | | | | | |
| [4 V/A] | | | | | |
| according to | | | | | |
| BJH [nm] | | | | | |
| Total cation | 65 | 63 | 20 | 20 | indeterminable |
| exchange | | | | | |
| capacity for | | | | | |
| smectites | | | | | |
| [meq/100 g] | | | | | |
| Silicate | | | | | |
| analysis (%) | | | | | |
| SiO₂ | 57 | 53.5 | 52.0 | 50.5 | 20.8 |
| Al₂O₃ | 18 | 16.8 | 6.6 | 3.6 | |
| Fe₂O₃ | 5.5 | 4.3 | 1.9 | 1.1 | |
| CaO | 2.75 | 6.0 | 1.1 | 4.8 | 93.8 |
| MgO | 4 | 3.9 | 26.0 | 25.6 | |
| Na₂O | 1.85 | 3.5 | 0.32 | 0.13 | |
| K₂O | n.d. | 1.3 | 1.4 | 0.8 | |
| TiO₂ | 0.4 | 0.3 | 0.25 | 0.12 | |
| Loss on | 10.5 | 9.7 | 9.5 | 12.7 | |
| ignition | | | | | |
| Dry sieve | ≦20 | ≦30 | n.d. | 20.8 | n.d. |
| residue on 63 μm | | | | | |
| [wt.-%] | | | | | |
| Dry sieve | n.d. | n.d. | 50 | 31.6 | n.d. |
| residue on 45 μm | | | | | |
| [wt.-%] | | | | | |
| Water | 9 ± 3 | 7 ± 3 | 9 ± 4 | 7 ± 4 | 4 |
| content | | | | | |
| [wt.-%] | | | | | |
| pH | 8.0 ± 1 | 10 ± 1 | 8.5 ± 1 | 8 ± 1 | 8.6 |
| [suspension, | | | | | |
| 5 wt.-%] | | | | | |

TABLE 1a
Proportions of accompanying minerals in the inorganic
adsorber materials:

| Parameter | Clay min. 1 | Clay min. 2 | Clay min. 3 | Clay min. 4 |
|---|---|---|---|---|
| Quartz [%] | 6-9 | 6-9 | 2-3 | 1-2 |
| Feldspar [%] | 1-4 | 1-4 | 2-3 | 1-2 |
| Calcite [%] | — | — | 0.5-1 | 3-4 |
| Kaolinite [%] | 1-2 | 1-2 | — | — |
| Mica [%] | 1-6 | 1-6 | — | — |
| Other minerals | 5-10 | 5-10 | — | — |
| [%] | | | | |

### Example 2

### Examination of the Adsorption of Chlorogenic Acid on Inorganic Adsorber Materials

Chlorogenic acid is a phenolic acid derivative which occurs in raw sunflower protein. In the tests described below, a chlorogenic acid concentration of 0.2 wt. -% in water was set and the adsorption of the chlorogenic acid was examined on the one hand at pH 6 and with a two molar NaCl solution, on the other hand at pH 8 and with a one molar NaCl solution. A 25 ml solution was used in each case. These are typical conditions, such as are also set for example with extraction from, sunflower proteins in order to clean up the proteins. Commercially available chlorogenic acid (Sigma-Aldrich Chemie GmbH, Taufkirchen) was used for the tests. The relative concentration of the chlorogenic acid before and after the adsorbent treatment was determined by measuring the UV absorbance at 324 nm. The corresponding adsorbent materials were stirred for 15 min. in the buffered chlorogenic solution. The adsorbent materials were then separated out by centrifugation and, after corresponding dilution, the chlorogenic acid concentration was determined photometrically at 324 nm. The suitability of the smectite clay minerals for chlorogenic acid adsorption was examined first in a dosage of 1 wt. -%, relative to the total solution. The results are presented in the following Table 2. It is shown that in particular the more hydrophobic clays based on stevensite/cerolite phases or saponite phases can deplete the chlorogenic add in the solution. A depletion with a calcium bentonite or a highly activated sodium bentonite was achieved, to a lesser extent here.

In a further test series, the best adsorbent materials from the first test series were used at a concentration of 5 wt. -%. In addition, hydrotalcite was examined as inorganic adsorber material. Two talc samples (Finntalc M 50 SQ, Westmin D 100, manufacturer/supplier: Hondo Minerals BV, 1040 HK Amsterdam, the Netherlands) were also examined as comparison systems. It was shown here that, compared with talc, the hydrophobic clays (saponite, stevensite/cerolite) had a substantially better bonding capacity for chlorogenic acid under the given conditions. A still greater bonding of the chlorogenic acid was able to be achieved by using hydrotalcite 1.

TABLE 2
Chlorogenic acid adsorption at pH 6

| | |
|---|---|
| Adsorbent | Adsorption |

1% adsorbent, 15 minutes

| | |
|---|---|
| Clay mineral 1 | 4.1% |
| Clay mineral 3 | 10.3% |
| Clay mineral 4 | 12.3% |

1% adsorbent, 30 minutes

| | |
|---|---|
| Clay mineral 1 | 4.9% |
| Clay mineral 3 | 9.7% |
| Clay mineral 4 | 11.4% |

1% adsorbent, 30 minutes, reduced NaCl concentration

| | |
|---|---|
| Clay mineral 1 | 5.0% |
| Clay mineral 3 | 7.4% |
| Clay mineral 4 | 8.6% |

5% adsorbent, 30 minutes

| | |
|---|---|
| Clay mineral 3 | 23.4% |
| Clay mineral 4 | 39.9% |
| Hydrotalcite 1 | 61.1% |
| Finntalc M50 - SQ | 4.0% |
| Westmin D 100 | 6.5% |

Repeated treatment with 5% adsorbent, in each case 30 minutes
Clay mineral 4

| | |
|---|---|
| 1^{st} treatment | 32.1% |
| 2^{nd} treatment | 55.6% |
| 3^{rd} treatment | 68.5% |

Hydrotalcite 1

| | |
|---|---|
| 1^{st} treatment | 64.0% |
| 2^{nd} treatment | 83.6% |
| 3^{rd} treatment | 93.0% |

TABLE 3
Chlorogenic acid adsorption at pH 8

| | |
|---|---|
| Adsorbent | Adsorption |

1% adsorbent, 15 minutes

| | |
|---|---|
| Clay mineral 1 | 5.5% |
| Clay mineral 3 | 8.8% |
| Clay mineral 4 | 11.6% |

1% adsorbent, 30 minutes

| | |
|---|---|
| Clay mineral 1 | 7.3% |
| Clay mineral 3 | 9.0% |
| Clay mineral 4 | 10.6% |

1% adsorbent, 30 minutes, reduced NaCl concentration

| | |
|---|---|
| Clay mineral 1 | 4.8% |
| Clay mineral 3 | 6.9% |
| Clay mineral 4 | 8.4% |

5% adsorbent, 30 minutes

| | |
|---|---|
| Clay mineral 3 | 27.6% |
| Clay mineral 4 | 39.8% |
| Hydrotalcite 1 | 61.8% |
| Finntalc M50 - SQ | 3.1% |
| Westmin D 100 | 6.4% |

Repeated treatment with 5% adsorbent, in each case 30 minutes
Clay mineral 4

| | |
|---|---|
| 1^{st} treatment | 25.0% |
| 2^{nd} treatment | 47.9% |
| 3^{rd} treatment | 59.6% |

Hydrotalcite 1

| | |
|---|---|
| 1^{st} treatment | 64.5% |
| 2^{nd} treatment | 82.0% |
| 3^{rd} treatment | 92.3% |

The results show in particular the suitability of hydrotalcite for adsorbing chlorogenic acid as well as the suitability of hydrophobic or partially hydrophobic clays based on stevensite/cerolite or saponite. Talc is less suitable for this application, which is possibly attributable to the small BET surface, area. Both examined products have a specific surface area of <20 m²/g,

### Example 3

### Adsorption of Sinapine/Sinapinic Acid from Rapeseed Extract

An extract which predominantly contained sinapine and sinapinic acid was used first to study the suitability of the adsorbent materials according to the invention for eliminating sinapine/sinapinic acid from raw rapeseed proteins. The concentration of sinapine/sinapinic acid was approx. 0.1 wt. -%, the sinapine proportion was approximately 90%. The reduction of the sinapine or sinapinic acid concentration was relative to the starting concentration of the extract used and photometrically examined after half an hour of treatment with the inorganic adsorber materials. The sinapine content was determined at a measuring wavelength of 324 nm by UV spectroscopy. The samples were filtered beforehand through a 0.45 μm syringe filter. The samples were also diluted with methanol for the photometric determination. In each case 25 ml solution was stirred with 1, 2 and 5 wt. -% of the inorganic adsorber materials. After 30 min. centrifugation took place and the remainder of the sinapine or of the sinapinic acid (giving the total) was determined in the supernatant. The reduction was relative to the starting concentration, wherein this was fixed at 100%. Adsorbent materials which showed the adsorption of sinapine/sinapinic acid in the pre-tests were tested in smaller quantities of application. It was shown here that in particular saponites, cerolites and also alkali-activated bentonites are suitable for separating out more than 50% of the starting sinapine/sinapinic acid mixture with relatively small quantities of adsorbent.

TABLE 4
Adsorption of sinapine and sinapinic acid

| | |
|---|---|
| Adsorbent | Adsorption |

5% adsorbent

| | |
|---|---|
| Clay mineral 1 | 66.8% |
| Clay mineral 3 | 73.5% |
| Clay mineral 4 | 84.3% |
| Hydrotalcite 1 | 50.5% |
| Finntalc M50 - SQ | 17.3% |
| Westmin D 100 | 41.5% |

2% adsorbent

| | |
|---|---|
| Clay mineral 1 | 50.9% |
| Clay mineral 3 | 64.6% |
| Clay mineral 4 | 75.8% |

1% adsorbent

| | |
|---|---|
| Clay mineral 1 | 43.1% |
| Clay mineral 3 | 53.6% |
| Clay mineral 4 | 62.3% |
| Clay mineral 2 | 62.3% |
| EXM 1842 | 21.8% |
| EXM 1843 | 45.3% |

2 × 1% adsorbent

| | |
|---|---|
| 1^{st} treatment clay mineral 4 | 62.0% |
| 2^{nd} treatment clay mineral 4 | 75.7% |
| 1^{st} treatment clay mineral 4 | 62.9% |
| 2^{nd} treatment hydrotalcite 1 | 74.3% |

According to the state of the art, no separation material for the targeted separation of sinapine was previously known. The data show that smectitic layered silicates are well suited to this application.

### Example 4

### Separation of Chlorogenic Acid and Caffeic Acid from Sunflower Protein Extract

An extract from coarse sunflower meal which was obtained as described above was used for the tests.

The two adsorber materials which showed the best results in the pre-tests of Example 2 for adsorbing chlorogenic acid were used for the tests.

a) Extraction at pH 6

Two-stage adsorptions were carried out with clay mineral 4 and hydrotalcite 1. In addition, a combination of clay mineral 4 and hydrotalcite 1 (one after the other) was carried out. The results of the analysis are presented in the following Table 5.

TABLE 5
Extraction of chlorogenic acid and caffeic acid from
sunflower protein extracts

| | Chlorogenic acid | | Caffeic acid | | |
|---|---|---|---|---|---|
| | Conc. | Conc. | Conc. | Conc. | Protein* |
| Sample | [μg/ml] | [%] | [μg/ml] | [%] | mg/ml |
| Supernatant of | 1912.3 | | 19.9 | | 9.4 |
| the | | | | | |
| pre-extraction | | | | | |
| Extract | 649.3 | 100 | 14.8 | 100 | 9.5 |
| Clay mineral 4 | 377.0 | 58 | 7.6 | 51 | 7.2 |
| 1^{st} stage | | | | | |
| Clay mineral 4 | 137.7 | 21 | 3.9 | 26 | 6.7 |
| 2^{nd} stage | | | | | |
| Hydrotalcite 1 | 47.2 | 7 | 0.2 | 2 | 12.0 |
| 1^{st} stage | | | | | |
| Hydrotalcite 1 | 2.5 | 0 | 0.0 | 0 | 5.2 |
| 2^{nd} stage | | | | | |
| Hydrotalcite 1 + | 10.9 | 2 | 0.0 | 0 | 6.2 |
| clay mineral 4 | | | | | |

*The protein values represent only guideline values because the preteins were partly missing due to deep-freeze storage.

Most of the phenolic acids remaining after the pre-extraction can be eliminated in the protein extract by treatment with inorganic adsorber materials. Hydrotalcite 1 proved to be the best. The concentration of chlorogenic and caffeic acid was already able to be reduced to 7 or 21 of the concentration in the extract by one adsorption step.

Clay mineral 4 was able to reduce the concentration, but clearly more poorly than hydrotalcite 1. Multi-stage methods improve the polyphenol separation, but also impair the protein yield.

b) Extraction at pH 8

The method was carried out analogously at pH 8. The results of the analysis are presented in the following table.

| | Chlorogenic acid | | Caffeic acid | | |
|---|---|---|---|---|---|
| | Conc. | Conc. | Conc. | Conc. | Protein |
| Sample | [μg/ml] | [%] | [μg/ml] | [%] | mg/ml |
| Supernatant of | 1912.3 | | 19.9 | | 9.4 |
| the | | | | | |
| pre-extraction | | | | | |
| Extract | 340.9 | 100 | 3.4 | 100 | 9.2 |
| Clay mineral 4 | 82.6 | 24 | 0.9 | 27 | 10.5 |
| 1^{st} stage | | | | | |
| Clay mineral 4 | 24.8 | 7 | 0.3 | 7 | 7.9 |
| 2^{nd} stage | | | | | |
| A3 = | 8.8 | 3 | 0.0 | 0 | 7.9 |
| hydrotalcite 1 | | | | | |
| 1^{st} stage | | | | | |
| Hydrotalcite 1 | 2.5 | 1 | 0.0 | 0 | 3.9 |
| 2^{nd} stage | | | | | |
| Hydrotalcite 1 + | 3.6 | 1 | 0.0 | 0 | 5.0 |
| clay mineral 4 | | | | | |

The separating-out of the polyphenols is very good at pH 8. With hydrotalcite 1, one step is again enough to almost completely separate out the phenolic acids. 2 stages are needed with clay mineral 4.

However, irreversible oxidation due to polyphenol oxidase may already occur at pH values of 8. Thus, the phenols are possibly no longer also ascertained.

Comparison of pH 8 and pH 6

The results are shown graphically in FIGS. 1a and 1b. A clear separating-out of the two phenolic acids chlorogenic acid and caffeic acid was possible at both pH values. A higher proportion of the phenolic acids was always able to be separated out at pH 8 than at pH 6. However, it would also be conceivable that already at pH 8 some of the chlorogenic and caffeic acid was oxidised and therefore a smaller content was measured. As this oxidation reaction is undesirable for sensory reasons, a treatment at lower pH values is to be preferred.

### Example 5

### Separation of Sinapine and Sinapinic Acid from Rapeseed Protein Extract

An extract from de-oiled coarse rapeseed meal which was prepared as described above was used for the tests.

The sinapine and sinapinic acid contents in the vegetable protein extracts were determined by means of HPLC. For this, a calibration with sinapine and sinapinic acid was carried out beforehand (see method part).

Results

The protein extraction was carried out at pH 7.4. The protein extract was treated in three stages relative to the vegetable protein extract with 1 wt. -% of the respective inorganic adsorber material.

Sinapine was already completely separated out in the first adsorption, step by clay mineral 4 and clay mineral 2. Where hydrotalcite 1 was used, a complete elimination was possible only in three adsorption steps. However, the protein was also almost completely separated out in this case.

An undesirable separating-out of protein took place to only a small extent when there was a single adsorption step. Only with clay mineral 2 were proteins separated out to below 60%.

A depletion of the sinapinic acid to 74% is possible in one adsorption step with clay mineral 4, The two other adsorbers were able to eliminate only approximately 10% (see also FIGS. 2a-2c).

TABLE 6
Sinapine and sinapinic acid contents in a rapeseed protein
extract before and after treatment with inorganic adsorber
materials

| | | | Sinapinic | |
|---|---|---|---|---|
| Inorganic | | Sinapine | acid | Protein |
| adsorber | | Conc. | Conc. | Conc. |
| material | Sample | [μg/ml] | [μg/ml] | [mg/ml] |
| | Extract | 258 | 189 | 17 |
| Clay mineral 4 | 1^{st} stage | n.d. | 139 | 12.6 |
| | 2^{nd} stage | n.d. | 110 | 10.8 |
| | 3^{rd} stage | 51 | 133 | 9.2 |
| Clay mineral 2 | 1^{st} stage | n.d. | 174 | 9.9 |
| | 2^{nd} stage | n.d. | 148 | 9.9 |
| | 3^{rd} stage | n.d. | 98 | 3.7 |
| Hydrotalcite 1 | 1^{st} stage | 183 | 175 | 15.54 |
| | 2^{nd} stage | 96 | 153 | 13.2 |
| | 3^{rd} stage | n.d. | 127 | 2.1 |

n.d. = not detectable

The results show the excellent suitability of smectite clays and/or cerolite-containing clays for separating out sinapine. As the data show, the less charged clays (saponite, cerolite) are better suited to the process because the protein concentration is reduced less with these. This can possibly be explained by the fact that the proteins are reciprocally bonded via a charge interaction (cation exchange). This would be greater for clay mineral 2 than for clay mineral 4 and clay mineral 3.

### Example 6

### Treatment of Protein Extracts from Coarse Rapeseed Meal with Different Adsorber Materials

In a further test series, the elimination of sinapine from a vegetable protein extract obtained by extraction from de-oiled coarse rapeseed meal by adsorption on inorganic adsorber materials was examined and compared with the adsorption on activated charcoal as weir as Amberlite® XAD-4 ion-exchange resin, Amber lite® XAD-4 was procured from Sigma Aldrich Chemie GmbH, D-82018 Taufkirchen, the activated charcoal (granulated, approx. 2.5 mm) was from Merck, Darmstadt. Amber lite®XAD-4 is a nonionic polymer adsorbent, resin based on polystyrene which, according to the details provided by the manufacturer, has a BET surface area of 725 m²/g.

5% adsorbent was added in each case to the vegetable protein extract, the mixture was stirred for 20 mm, and then centrifuged at 3000 g for 5 mm. The supernatant was examined by means of HPLC analysis. The sinapine contents of the supernatant after adsorbent treatment, were normalized to the blank value, i.e. the sinapine content of the original extract.

The results are summarized in Table 7. The results are reproduced graphically in FIG. 3.

Both Table 7 and FIG. 3 show that all of the adsorbent materials can reduce the sinapine content of the vegetable protein extract in a dosage of 5%. However, a comparison of the data shows that the two clay minerals (cerolite-containing clay as well as saponite) reduce the sinapine content of the protein extract clearly more strongly than activated charcoal and Amberlite®XAD-4, which would usually be used according to the state of the art.

TABLE 7
Reduction of the sinapine content in a rapeseed protein
extract by treatment with different absorber materials

| | |
|---|---|
| Blank value | 100 |
| (=without absorber) | |
| Activated charcoal | 44.9 |
| Amberlite XAD-4 | 60.4 |
| Clay mineral 4 | 6.6 |
| Clay mineral 3 | 10.4 |
| Blank value | 100 |
| (=without absorber) | |

### Example 7

### Elimination of Inappropriate Fragrances from Soya Protein Extract

### Procedure

To obtain vegetable protein concentrates with reduced legume flavour, the protein extracts obtained from the vegetable raw materials were further cleaned up by an adsorption step.

Several adsorbers (hydrophobic, anionic, cationic) were added to protein extracts from soya or pea at different pH values. After a previously fixed incubation time the adsorber was separated out and the extracts were evaluated in sensory terms compared with control extracts. Moreover, the protein content in the extract was determined to establish whether the proteins are also absorptively precipitated under the respective conditions. The proteins were analyzed by means of photometric measurement after a biuret reaction.

To prepare the protein extracts, an acid pre-extract ion was carried out in part before the actual protein extraction.

The obtained protein extracts were subjected to an immediate sensory test. The solutions treated with adsorber were compared with the untreated extracts. A so-called triangular test in which in each case two different samples (A+B) were compared with each other was carried out for the sensory evaluation. For this, each test subject received a sample set comprising 3 samples (A,A,B or A,B,B) which were coded with three-digit random numbers. The testers did not know which of the samples was duplicated. By comparing odour and flavour, the test subjects were to discover which of the two samples is different from the others and which distinguishing features are different.

The following were sampled as distinguishing features of the odour:
grassy/green
bean-like/pea-like
grainy
sticky

The following were sampled as distinguishing features of the flavour:
bitter
grassy/green
bean-like/pea-like
grainy
sticky

In the evaluation, it was established how many of the test subjects correctly identified the deviating sample. The probability with which the samples differ significantly can be derived from this. The probability of a significant difference between samples A and B can be read from the following table. It is shown how many correct answers are needed to obtain a certain significance level. A difference is considered as significant if the significance level is 0.05 at most, which corresponds to a probability of error of 5%.

Table for binomially distributed values for the triangular test

| | Minimum number of correct decisions at | | | | |
|---|---|---|---|---|---|
| Number of | a significance level of | | | | |
| testers | =0.2 | =0.1 | =0.05 | =0.01 | =0.001 |
| or tests | (n.s.) | (n.s.) | (s.) | (h.s.) | (v.h.s.) |
| 6 | 4 | 5 | 5 | 6 | — |
| 7 | 4 | 5 | 5 | 6 | 7 |
| 8 | 5 | 5 | 6 | 7 | 8 |
| 9 | 5 | 6 | 6 | 7 | 8 |
| 10 | 6 | 6 | 7 | 8 | 9 |

n.s. = not significant
s. = significant
h.s. = highly significant
v.h.s. = very highly significant
References: Praxishandbuch Sensorik in der Produktentwicklung and Qualitätssicherung, Busch-Stockfisch, Behr's Verlag

The studies were carried out with 8-10 testers.

### Example 8

### Elimination of Inappropriate Fragrances from Soya Protein

Test 1: pH 8, without pre-extraction

Firstly it was examined to what extent the treatment with inorganic adsorber material reduces the protein yield.

For this, an extraction of soya protein was carried out at pH 8.0 and the protein yields with and without adsorber treatment compared with each other. The results are reproduced in Table 8:

TABLE 8
Measurement of the protein adsorption when treating soya
protein extracts with inorganic adsorber materials

| | Protein content |
|---|---|
| Sample | [mg/ml] |
| Without adsorbent | 26.8 |
| treatment | |
| Clay mineral 1 | 26 |
| Hydrotalcite 1 | 26.5 |
| Clay mineral 3 | 24.7 |
| Clay mineral 4 | 26 |

The adsorbers did not lead to a precipitation of protein and therefore did not impair the protein yield.

Test 2: pH 7, without pre-extraction

An extraction of soya proteins was carried out at pH 7.0 analogously to test 1 and the protein yields with and without adsorber treatment were compared with each other. The results are summarized in Table 9:

TABLE 9
Protein content of a soya protein extract before and after
treatment with different inorganic adsorber materials

| | Protein content |
|---|---|
| Sample | [mg/ml] |
| Blank value | 22.9 |
| Clay mineral 1 | 21.6 |
| Hydrotalcite 1 | 22.3 |
| Clay mineral 3 | 20.9 |
| Clay mineral 4 | 21.7 |

The inorganic adsorber materials did not lead to a precipitation of protein and therefore did not impair the protein yield. Overall, the yield is somewhat poorer than at pH 8, which is due to the somewhat poorer solubility of the proteins at lower pH values.

Protein, extractions can possibly already lead to slight protein hydrolysis at pH values above 8 and are therefore not as mild. The following tests were therefore carried out at pH values <8.

Test 3: pH 7, comparison of products with and without pre-extraction

Soya protein extractions were carried out at pH 7.0, some with and some without pre-extraction. The protein yields with and without adsorber treatment were compared, with each other.

The prepared extracts were evaluated in sensory terms. The results can be seen in Table 10.

TABLE 10
Sensory evaluation of soya protein concentrates when
conducting a pre-extraction

| Sample | | | | | |
|---|---|---|---|---|---|
| triangle (in | Deviating | | | | |
| each case | sample | | | | |
| adsorber | correctly | | Deviating | Deviating | Proteins |
| against | identified | | features | features | content |
| blank value) | [%] | Significance | odour* | flavour* | [mg/ml] |
| BV (without | | | | | 23.8 |
| PE) | | | | | |
| BV | | | | | 11.8 |
| (with PE) | | | | | |
| Clay mineral | 62.5 | 0.1 | grassy | bitter | 22.8 |
| 3 (without | | | bean-like | (grassy) | |
| PE) | | | grainy | (bean-like) | |
| Clay mineral | 80 | 0.01 | grassy | bitter | 11.3 |
| 3 (with PE) | | highly | bean-like | grassy | |
| | | significant | grainy | bean-like | |
| | | | | sticky | |
| Clay mineral | 37.5 | >0.2 | (grassy) | (bitter) | 23.8 |
| 4 (without | | | | (grassy) | |
| PE) | | | | | |
| Clay mineral | 88.8 | 0.001 | grassy | bitter | 10 |
| 4 (with PE) | | very highly | (bean-like) | grassy | |
| | | significant | (grainy) | bean-like | |
| | | | | sticky | |
| Hydrotalcite | 62.5 | 0.1 | (grassy) | bitter | 21.9 |
| 1 (without | | | (bean-like) | bean-like | |
| PE) | | | | (grassy) | |
| Hydrotalcite | 33.3 | >0.2 | | (grassy) | 11.2 |
| 1 (with PE) | | | | (sticky) | |

BV = blank value, i.e. sample without adsorber treatment
PE = pre-extraction
*At least 3 test subjects named these properties. Values in brackets: 2 test subjects named this property

Due to the pre-extraction, the protein yield decreases clearly, as proteins are lost during the pre-extraction. However, the sensory quality of the samples and thus the added value of the proteins are clearly better. The protein yields were not substantially reduced by the adsorber treatment.

The samples prepared with the adsorbers clay mineral 3 or day mineral 4, in each case after pre-extraction, performed best. With these materials, all of the unwanted flavour impressions (bitter, grassy, bean-like and sticky) were able to be reduced. The differences were highly significant or very highly significant.

As the samples without pre-extraction were clearly poorer, ail of the further tests were carried out with pre-extraction.

Test 7: pH 7—multi-stage adsorption

The effectiveness of the separating-out of inappropriate fragrances was to be augmented by several adsorption steps.

For this, several adsorption steps were carried out with a suitable adsorber and the intermediate stages and final stage were evaluated. An acid pre-extraction and protein extraction was carried out at pH 7.0.

The results are to be found in Table 11.

TABLE 11
Sensory evaluation of soya protein extracts after
multi-stage extraction of the vegetable protein at pH = 7

| Sample | | | | | |
|---|---|---|---|---|---|
| triangle | | | | | |
| (in | | | | | |
| each case | Deviating | | | | |
| adsorber | sample | | | | |
| against | correctly | | Deviating | Deviating | Proteins |
| blank | identified | | features | features | content |
| value) | [%] | Significance | odour* | flavour* | [mg/ml] |
| BV | | | | | 13.8 |
| Clay | 33 | >0.2 | (bean-like/ | — | 11.6 |
| mineral 3 | | | pea-like) | | |
| one-stage | | | | | |
| Clay | | | not tested | not tested | 11.2 |
| mineral 3 | | | | | |
| two-stage | | | | | |
| Clay | 90 | 0.001 | grassy/green | bitter | 9.9 |
| mineral 3 | | very highly | bean-like/ | grassy/ | |
| three-stage | | significant | pea-like | green | |
| | | | grainy | bean-like | |
| | | | sticky | grainy | |
| | | | | (sticky) | |

BV = blank value, i.e. sample without adsorber treatment
*At least 3 test subjects named these properties.

Values in brackets: 2 test subjects named this property

The sensory qualities were able to be clearly improved by several adsorption stages. Bitter, grassy, bean-like and grainy fragrances were reduced. The protein yield was only a little poorer. Above all, the more neutral flavour of the thus-obtained proteins is important for a commercial use of the proteins. The found protein loss is acceptable.

### Example 9

### Elimination of Inappropriate Fragrances from Raw Pea Protein

Using the same procedure as in Example 8, the elimination of inappropriate fragrances from pea protein extracts with inorganic adsorber materials was examined.

All of the extractions were carried out with pre-extraction, as it had been shown in the tests with soya that the products were not acceptable in sensory terms without pre-extraction. Because of the findings from the soya tests, the protein contents for these preliminary tests were not analyzed systematically.

The sensory evaluation was carried out as a triangular test. Protein extracts with and without adsorber treatment were tasted. The deviating sample was to be identified and the deviating properties established.

### Test 1: pH 8.5

After an acid pre-extraction, the proteins were extracted at pH 8.5 and then treated with the corresponding adsorber. The protein yields with and without adsorber treatment were compared with each other. Except for EX M 1840, the sensory qualities were able to be significantly improved. Above all, bitter, sometimes also green and pea-like, fragrance, flavour and/or colour components were able to be separated out. The results can be found in Table 12.

TABLE 12
Sensory evaluation of pea protein concentrates with
extraction at pH 8.5

| Sample | | | | |
|---|---|---|---|---|
| triangle (in | Deviating | | | |
| each case | sample | | | |
| adsorber | correctly | | | Deviating |
| against blank | identified | | Deviating | features |
| value) | [%] | Significance | features odour* | flavour* |
| Blank value | | | | |
| Clay mineral 3 | 75 | 0.05 | grassy/green | bitter |
| | | significant | (bean-like/ | grassy/green |
| | | | pea-like) | (bean-like/ |
| | | | | pea-like) |
| Clay mineral 4 | 87.5 | 0.01 | bean-like/ | bitter |
| | | highly | pea-like | (grassy/ |
| | | significant | (grassy/green) | green) |
| Hydrotalcite 1 | 71.4 | 0.05 | — | (grainy) |
| | | significant | | |
| Clay mineral 2 | 85.7 | 0.01 | grassy/green | bitter |
| | | highly | bean-like/ | grassy/green |
| | | significant | pea-like | bean-like/ |
| | | | grainy | pea-like |
| | | | (sticky) | |
| Westmin D 100 | 37.5 | <0.2 | — | — |

BV = blank value, i.e. sample without adsorber treatment
*At least 3 test subjects named these properties. Values in brackets: 2 test subjects named this property For individual results, see enclosure

### Test 2: pH 7

After an acid pre-extraction, the proteins were extracted at pH 7.0 and then treated with the corresponding adsorber. The protein yields with and without adsorber treatment were compared with each other. The results are summarised in Table 13.

TABLE 13
Sensory evaluation of pea protein concentrate obtained
after extraction at pH 7

| Sample | | | | |
|---|---|---|---|---|
| triangle (in | Deviating | | | |
| each case | sample | | | |
| adsorber | correctly | | Deviating | Deviating |
| against blank | identified | | features | features |
| value) | [%] | Significance | odour* | flavour* |
| BV | | | | |
| Clay mineral 3 | 86 | 0.01 | — | bitter |
| | | highly | | |
| | | significant | | |
| Clay mineral 4 | 86 | 0.01 | grainy | grassy/green |
| | | highly | sticky | bean-like/ |
| | | significant | (bean-like/ | pea-like |
| | | | pea-like) | sticky |
| | | | | (bitter) |
| Hydrotalcite 1 | 100 | 0.001 | (bean-like/ | bean-like/ |
| | | very highly | pea-like) | pea-like |
| | | significant | | (grassy/green) |
| Clay mineral 2 | 67 | 0.2 | (grainy) | grassy/green |
| Westmin D 100 | 67 | 0.2 | — | — |

BV = blank value, i.e. sample without adsorber treatment
*At least 3 test subjects named these properties. Values in brackets: 2 test subjects named this property

The flavour of the extracts was able to be significantly improved by the adsorber treatment. Above all, a treatment with clay mineral 4 and hydrotalcite 1 was able to reduce undesirable flavour impressions, such as grassy and pea-like.

1. Method for eliminating unwanted accompanying substances from vegetable proteins, at least comprising the following steps:
i) extracting a vegetable raw material using an extracting agent, wherein a vegetable protein extract is obtained;
ii) adding an inorganic adsorber material to the vegetable protein extract, wherein unwanted accompanying substances are bonded to the inorganic adsorber material.

2. Method according to claim 1, additionally comprising one or more steps selected from the group consisting of
i) separating insoluble constituents of the vegetable raw material from the vegetable protein extract;
ii) separating the inorganic adsorber material from the vegetable protein extract;
iii) separating vegetable protein from the vegetable protein extract;
iv) decomposing the vegetable raw material;
v) pre-extracting the vegetable raw material,
and mechanically separating the solid from the liquid phase after the pre-extraction the vegetable raw material;
vi) separating the inorganic adsorber material from the vegetable protein extract and repeating the addition of the inorganic adsorber material; and
vii) neutralizing the precipitated vegetable protein.

3. Method according to claim 1, wherein
i) the vegetable protein extract is set to a pH in the range of from 3-10; and/or
ii) the separating-out of the inorganic adsorber material takes place mechanically; and/or
iii) the concentration of the inorganic adsorber material is 0.1-20 wt. relative to the weight of the vegetable raw material used; and/or
iv) the separating-out of the inorganic adsorber material takes place mechanically; and/or
v) the separating-out of the protein takes place by
a) precipitation of the dissolved protein out of the solution;
b) solid/liquid separation of the precipitated protein from the supernatant; and
c) drying of the vegetable protein extract.

4. Method according to claim 1, wherein the addition of the inorganic adsorber material already takes place during the extraction of the vegetable raw material with the extracting agent and/or during the pre-extraction of the vegetable raw material.

5. Method according to claim 1, wherein the vegetable raw material is selected from the group consisting of oilseeds, pressing residues of oil production, and legumes.

6. Method according to claim 1, wherein the unwanted accompanying substances.

7. Method according to claim 1, wherein the inorganic adsorber material is selected from clays.

8. Method according to claim 7, wherein the clays are selected from the group consisting of anionic clays, cationic clays and uncharged clays.

9. Method according to claim 8, wherein the anionic clays are selected from the group consisting of
i) smectites; and
ii) vermiculites.

10. Method according to claim 8, wherein the uncharged clays are selected from the group consisting of
i) cerolite; and
ii) minerals of the talc group.

11. Method according to claim 8, wherein the cationic clays are hydrotalcite.

12. Method according to claim 7, wherein the clays are selected from the group consisting of stevensite, cerolite, saponite and vermiculite.

13. Method according to claim 8, wherein a clays contents of the inorganic adsorber material is
i) ≧30% for cerolite;
ii) ≧50%) for bentonite;
iii) ≧50% for montmorillonite;
iv) ≧50% for saponite; and
v) ≧30% for vermiculite.

14. Vegetable protein extracts wherein unwanted accompanying substances have been eliminated by the method according to claim 8.

15. Vegetable protein extracts according to claim 14, wherein the unwanted accompanying substances are selected from the group of polyphenols chlorogenic acid.

16. Vegetable protein extracts according to claim 15, wherein the unwanted accompanying substances are selected from the group consisting of hydroxycinnamic acids and phenolic acids and the clays are selected from the group of hydrotalcites.

17. Method according to claim 1, wherein the unwanted accompanying substances are selected from the group consisting of fragrance, flavour, colour components, or a mixture thereof.

18. Method according to claim 2, wherein the decomposing the vegetable raw material comprises shelling, grinding and/or flaking.

19. Method according to claim 2, wherein the decomposing the vegetable raw material comprises shelling, grinding and/or flaking in 5 to 10 times the quantity of water at acid pH values.

20. Method according to claim 2, wherein the decomposing the vegetable raw material comprises shelling, grinding and/or flaking at temperatures ≦10° C.
